(19) United States
(12) Patent Application Publication
(10) Pub. No.: US 2023/0082241 A1
(43) Pub. Date: Mar. 16, 2023

(54) CARBOHYDRATE-BASED ADHESIVES

(71) Applicant: CARGILL, INCORPORATED, Wayzata, MN (US)

(72) Inventors: Kevin R. ANDERSON, Cedar Rapids, IA (US); Flave Eugene MARKLAND, Atkins, IA (US); Shuang ZHOU, Marion, IA (US)

(73) Assignee: CARGILL, INCORPORATED, Wayzata, MN (US)

(21) Appl. No.: 17/759,217

(22) PCT Filed: Feb. 3, 2021
(86) PCT No.: PCT/US2021/016318

§ 371 Date: Jul. 21, 2022

Related U.S. Application Data
(60) Provisional application No. 62/969,944, filed on Feb. 4, 2020.

(51) Int. Cl. C08L 1/02

(52) U.S. Cl. CPC C08L 1/02

(57) ABSTRACT

Various embodiments disclosed relate to a composition including a fibrous material and a binder composition. The binder composition includes at least one carbohydrate and at least one branched (poly)amine comprising a plurality of primary amines, wherein the majority of the plurality of primary amines are attached to a methylene group. Various embodiments disclosed further relate to a composition including a reaction product and a fibrous material mixed therein. The reaction product includes at least one monosaccharide and at least one branched (poly)amine comprising a plurality of primary amines, wherein each of the plurality of primary amines is attached to a methylene group. In various embodiments, the composition is used to make an engineered wood product.

### CROSS-REFERENCE TO RELATED APPLICATIONS

This application claims the benefit of U.S. Provisional Patent Application No. 62/969,944, filed Feb. 4, 2020, which is hereby incorporated by reference herein in its entirety.

### BACKGROUND

Particle boards are conventionally made with binders using urea formaldehyde (UF) and melamine urea formaldehyde (MUF). In recent years, the demand of no-added formaldehyde (NAF) wood products has rapidly increased. As of June 2018, it is illegal to manufacture or import composite wood products with high amounts of formaldehyde in the United States.

### SUMMARY OF THE DISCLOSURE

Due to restrictions on the use of formaldehyde-containing binders, a wood binder composition with an alternative cross-linker is desired.

The present disclosure provides a composition containing a fibrous material and a binder. The binder includes at least one carbohydrate, at least one branched (poly)amine comprising a plurality of primary amines, wherein the majority of the plurality of primary amines are attached to methylene groups and an alkalizing agent, for example, sodium hydroxide, potassium hydroxide, magnesium hydroxide, calcium hydroxide, or mixtures thereof.

Aspects of the disclosure relate to a composition that is a binder that can be used to create engineered wood products with good dry strength and water resistance.

The compositions described herein can contain a non-formaldehyde cross-linker in the form of the branched (poly)amine and avoids various health hazards associated with formaldehyde-based binders.

Compositions using a carbohydrate allows for alternative uses of monosaccharides (e.g., at least 80 wt. %, at least 85 wt. %, at least 90 wt. % or at least 95 wt. % monosaccharides), including fructose, glucose, and combinations thereof, to create the binder compositions described herein.

The disclosure also provides a composition containing the reaction product of at least one monosaccharide and at least one branched (poly)amine, and a cellulosic fibrous material cured by the reaction product. The at least one branched (poly)amine contains a plurality of primary amines, where each of the plurality of primary amines is attached to a methylene (—CH₂—) group.

The disclosure also provides an engineered wood product containing the composition of the reaction product and the cellulosic fibrous material.

The disclosure also provides a method of making an engineered wood product including combining at least one monosaccharide (e.g., fructose, glucose, galactose, mannose, and combinations thereof) with at least one branched (poly)amine comprising a plurality of primary amines, wherein each of the plurality of primary amines is attached to a methylene group to form a binder composition; combining the binder composition with a fibrous material to form a mixture and curing the mixture.

### DETAILED DESCRIPTION

Reference will now be made in detail to aspects of the disclosed subject matter. While the disclosed subject matter will be described in conjunction with the enumerated claims, it will be understood that the exemplified subject matter is not intended to limit the claims to the disclosed subject matter.

Formaldehyde type binders, such as binders formulated with urea formaldehyde (UF) or melamine urea formaldehyde (MUF), are used ubiquitously in wood products. However, a large number of markets are phasing out formaldehyde wood products due to associated health risks, such as release of noxious compounds.

As an alternative, monosaccharides, such as fructose and glucose, have the potential for use in wood product binders. These binders have a reduced health hazards associated with them compared to UF or MUF. The proposed carbohydrate-based binders use amine-type cross-linking agents. Specifically, branched cross-linkers, such as polyethylenimine (PEI), 4-aminoethyl-1,8 octanediamine (TAN), or tris(aminoethyl)amine (TAEA) can be used to make binders for engineered wood products having good dry strength and moisture resistance, comparable to formaldehyde type binders. Effective, stable, but affordable cross-linkers are discussed herein.

In particular, branched (poly)amines can cure quickly with monosaccharides, such as fructose and glucose, under conventional particle board curing conditions, compared to linear polyamines, which produce binders that make fragile particle board products. Branched polyamines bearing primary amine groups attached to methylene groups or secondary carbons, in particular, create strong cross-linking with a carbohydrate to bind wood fiber together. Branched polyamines with three or more than three primary amine groups attached to secondary carbons perform well as cross-linkers in wood binders. The wood products produced with these types of cross-linkers have dry strength and water resistance comparable to conventional formaldehyde binders-based wood products.

Additionally, discussed herein, a series of branched (poly)amines that are the reaction products of readily available materials can be used as cross-linkers. These reactions product cross-linkers can have, for example, branched primary amine groups attached to secondary carbons or methylene groups. For example, the reaction product of trimethylolpropane triglycidyl ether with ethylenediamine (EDA) is a branched (poly)amine that can act as a cross-linker for wood product binder.

An alkalizing agent, such as sodium hydroxide, in the binder composition can facilitate manufacturing of engineered wood products using that binder. The addition of an alkalizing agent can enhance the curing of the wood product and increase overall dry strength. The alkalizing agent can allow easy release of a particle board during processing. This can occur where the alkalizing agent facilitate more complete curing of the binder composition. When the binder composition is fully cured, it is less sticky and easier to remove from a mold.

Carbohydrates, including monosaccharides such as glucose, fructose, dextrose syrups, glucose syrups or high fructose syrups, can produce good wood binders. Dextrose syrups can be glucose syrups that can contain primarily dextrose. These monosaccharides produce binders and wood products with similar performance. Typically, the carbohydrate comprises at least 60 by weight of a monosaccharide (such as glucose, fructose, and/or mixtures thereof, for example at least 63 wt %, at least 70 wt %, at least 80 wt %, at least 85 wt %, at least 90 wt %, at least 95 wt %).

As described herein, a wood product can contain, for example, a binder composition, where the binder composition includes at least one carbohydrate (e.g., a monosaccharide such as glucose or fructose), as described above and at least one branched (poly)amine including a plurality of primary amines, where the majority of the plurality of primary amines are attached to methylene groups.

### Polyamine Cross-Linker

The cross-linker in the binder can be, for example, a branched (poly)amine Specifically, the branched (poly)amine incudes at least one primary amine, and preferably at least three primary amines. At least one, or a majority of primary amines, can be attached to secondary carbons or methylene groups (—CH₂—).

The branched (poly)amine can be, for example, polyethylenimine (PEI). The chemical structure for a branched PEI unit is show in formula (I) below:

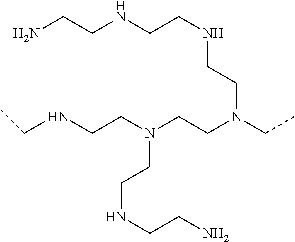

PEI is a polymer with a repeating unit composed of amine and an ethylene spacer. In particular, branched PEI with a molecular weight of about 1800 can be used as a cross-linker for wood binders due to its branched structure with a multitude of primary amines.

The branched (poly)amine can be, for example, 4-aminoethyl-1,8 octanediamine (TAN). The chemical structure for TAN is show in formula (II) below:

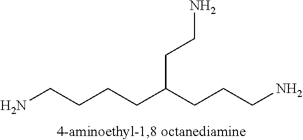 [SMILES: NCCCCC(CCN)CCCN]

TAN includes three primary amines separated from a central carbon by three aliphatic chains. The primary amines in TAN are branched and not sterically hindered. TAN has a molecular weight of about 173.3 g/mol. TAN is a highly reactive cross-linker for fructose- and/or glucose-based binders, resulting in wood products with higher bond strength and water resistance.

The branched (poly)amine can be, for example, tris(aminoethyl)amine (TAEA). The chemical structure for TAEA is show in formula (III) below:

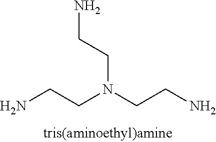

TAEA includes one tertiary amine and three primary amines branching from the tertiary amine. The primary amines are not sterically hindered. TAEA has a molecular weight of about 146.24 g/mol.

The cross-linker can, for example, be the reaction product of trimethylolpropane triglycidyl ether (TMPTGE) with an appropriate amine. The amine can be, for example, ethylenediamine (EDA), diethylenetriamine, triethylenetetramine, tetraethylenepentamine, pentaethylenehexamine, ammonia, or other sources of primary amine groups. An example reaction product is shown below in the reaction of TMPTGE with EDA:

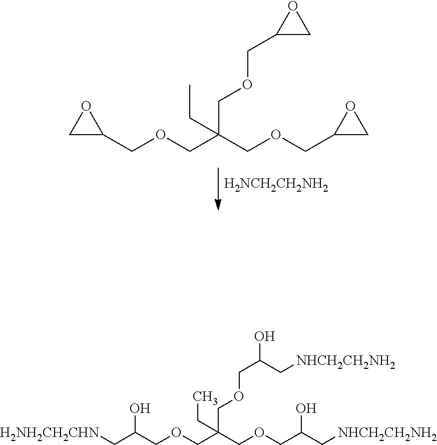

The reaction product of TMPTGE and EDA produces both a branched (poly)amine ether compound (containing multiple primary amines attached to methylene groups) and polyamine ether polymers or oligomers. The cross-linker compound can be used in the wood binder composition.

Alternative reaction product crosslinkers, using TMPTGE and alternatives to EDA, can include, but are not limited to, the following:

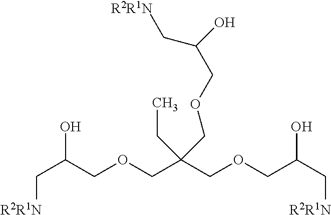

Where R¹ is hydrogen or R³:

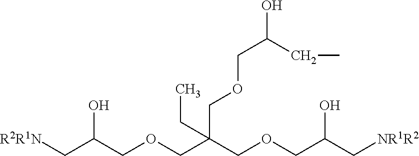

R³ can be attached to the nitrogen at the CH₂ group above. R² is hydrogen, —(CH₂)ₙNR⁴R⁵ or —(CH₂CH₂NR⁴R⁵)ₘCH₂CH₂NR⁴R⁵ where n=2-9, m=1-4, and R⁴ and R⁵ are defined as hydrogen or R³.

The reaction product cross-linkers produce engineered wood products with good mechanical properties and water resistance, comparable to conventional UF wood products. For example, binders made with the reaction product cross-linkers can have a wet swell percent (under standard ASTM D1037 wet swell testing) of less than about 40% (e.g., less than about 30%, or less than about 25%). At about 10% to about 13% binder content based on dry wood fiber weight and a density of about 0.50 g/cm³ to about 0.60 g/cm³ (e.g., about 0.51 g/cm³ to about 0.55 g/cm³), the binders made with the reaction product cross-linkers can have a dry strength of at least about 2.0 N/mm² (e.g., at least about 2.6 N/mm², at least about 3.3 N/mm², or at least about 3.8 N/mm²). The dry strength of wood products using an binder containing the reaction product cross-linkers increases as the amount of cross-linker in the binder increases.

In any of the cross-linkers, the primary amine groups should not be sterically hindered. Branched, non-hindered amine groups can more easily interact with aldehyde and/or ketone groups of the carbohydrate in the binder composition, resulting in a cross-linked binder composition.

The branched (poly)amine cross-linker material can have, for example, a molecular weight of about 140 g/mol to about 750,000 g/mol (e.g., about 140 g/mol to about 65,000 g/mol, or about 140 g/mol to about 5,000 g/mol, or about 140 g/mol to about 1,000 g/mol). Based on the dry weight of the binder contents (e.g., dry solid amount of the ingredients), the binder mixture can contain, for example, at least about 10.0 wt. % branched (poly)amine, or alternatively about 10.0 wt. % to about 80.0 wt. % of the total binder (e.g., about 10.0 wt. % to about 18.0 wt. %, or about 11.0 wt. % to about 16.0 wt. %, or about 14 wt. % to about 16.0 wt. %).

### Carbohydrate

The binder composition can contain a carbohydrate, such as, for example, a monosaccharide. The monosaccharide can be, for example, fructose, glucose, galactose, mannose, or combinations thereof. The monosaccharide preferably is an aldose and/or a ketose, such as fructose and/or glucose, to allow interaction with the branched (poly)amine cross-linker.

Compounds other than carbohydrates can be used, or can be used in combination with carbohydrates. One such compound is hydroxymethylfurfural (HMF):

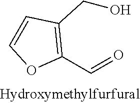

Monosaccharides allow for high dry strength and water resistance of resulting engineered wood products. This is due in part to the aldehyde and/or ketone group of the monosaccharides interacting with the amine groups in the polyamine cross-linker to create a cross-linked binder composition. The monosaccharides can be aldose and/or ketose. Aldoses and ketoses are sugars that have a free aldehyde group or a free ketone group. Monosaccharides are aldoses and/or ketoses, along with some disaccharides. Aldoses and ketoses, such as the monosaccharides discussed herein, can react with amine groups in the cross-linkers discussed herein. The aldehyde or ketone groups of the sugars are likely the reaction loci with the amine groups from the cross-linker molecules. The reaction of the monosaccharides with the branched (poly)amines is exothermic.

The carbohydrate can be a high fructose syrup containing about 40 wt. % to about 60 wt. % fructose and about 60 wt. % to about 40 wt. % glucose.

The carbohydrate can be corn syrups with high DE (dextrose equivalent), such as corn syrups with a DE of from about 60 to about 99 or a DE from about 80 to about 96, for example a DE from about 85 to about 95. A high DE corn syrup can contain a high glucose weight percent based on dry solids content. For example, a 95 DE corn syrup can contain approximately 94 wt. % to about 96 wt. % glucose based on dry solids content. High DE corn syrup can achieve strong bonding and maintain water resistance. Corn syrups with low DE likely have a smaller amount of reducing ends, resulting in lower water resistance and dry strength. Additionally, more viscous corn syrups are less desirable, as more viscous corn syrups may prevent reactant molecule motion within the binder composition.

The binder composition can be, for example, about 20.0 wt. % to about 95.0 wt. % of the at least one carbohydrate, or preferably about 50 wt. % to about 80.0 wt. %, or about 60.0 wt. % to about 75.0 wt. %, based on the dry solids present in the binder.

### Alkalizing Agent

The binder composition can also contain an alkalizing agent to regulate the reaction product environment.

The alkalizing agent can be, for example, a Group IA or IIA alkali metal salts, such as sodium hydroxide, potassium hydroxide, magnesium hydroxide, or calcium hydroxide. In general, the alkalizing agent can adjust the pH to a basic pH of about 9.0 or above, such as at least 10, at least 10.5 or at least 11.

An alkalizing agent can neutralize sugar acid resulted from the reaction of sugar and the amine crosslinkers to prevent amines from being protonated, promoting cross-linking in the binder composition. An alkalizing agent can also interact with fibrous material (e.g., wood fiber) in the wood binder, promoting penetration of the fibrous material in the binder composition.

The alkalizing agent can be, for example, about 0.1 wt. % to about 25.0 wt. % of the binder composition, preferably about 5.0 wt. % to about 20.0 wt. % of the composition (e.g., about 6.0 wt. % to about 19.0 wt. %, about 7.0 wt. % to about 18.0 wt. %, about 8.0 wt. % to about 17.0 wt. %, about 9.0 wt. % to about 16.0 wt. %, or about 10.0 wt. % to about 15.0 wt. %). In the absence of an alkalizing agent, the surface of hot particle boards made with the binder composition could be sticky and might not release easily from molds.

### Wood Product Adhesive

The binder composition containing the carbohydrate (or alternative) and branched (poly)amine cross-linker can be used to create a wood binder for wood products such as particle board or other wood products containing wood fiber and/or cellulosic fibrous material.

The binder composition can contain, for example, the reaction product of a monosaccharide with a branched (poly)amine. The monosaccharide can be, for example, about 20.0 wt. % to about 95.0 wt. %, about 70.0 wt. % to about 90.0 wt. % or about 80 wt. % to about 86 wt. % based on the dry weight of the binder composition. The branched (poly)amine cross-linker can contain one or more primary amines attached to methylene groups. The branched (poly)amine cross-linker can be, for example, about 10.0 wt. % to about 80.0 wt. % based on the dry weight of the binder composition. Optionally, the binder composition can contain an alkalizing agent (as described above), of about 0.1% to about 25.0 wt. % based on the dry weight of the binder composition. The monosaccharide and the branched (poly)amine can be stored separately until the engineered wood product will be formed.

The fibrous material can be mixed with the binder to create a mixture (e.g., a precursor to particle board or other wood product). The fibrous material comprises a plurality of wood fibers or other cellulosic material. The wood binder (e.g., the monosaccharide mixed with the branched (poly)amine, and other components, such as alkalizing agent) can be, for example, about 5 wt. % to about 30 wt. %, about 5 wt. % to about 15 wt. %, about 6 wt. % to about 14 wt. % or about 8 wt. % to about 13 wt. % of the total dry weight of the mixture (e.g., fibrous material plus wood binder) after curing. Particle board, or various engineered wood products, can be made with the mixture of wood binder and fibrous material by curing the mixture.

The total dry solids of the binder can, for example, comprise from about 20 wt. % to about 75 wt. % dry solids (the rest being water), preferably from about 30 wt. % to about 65 wt. % dry solids, and more preferably from about 30 wt. % to about 60 wt. % by weight dry solids. These compositions can, for example, be used for the manufacture of engineered wood having at least one ply. For example, from about 32 wt. % to about 37 wt. % dry solids can be common in wood binder composition for engineered wood products having at least one ply. And from about 40 wt. % to about 55 wt. % dry solids can be common in the wood binder composition for MDF (medium density fiberboard), HDF (high density fiberboard), particle board, and OSB (oriented strand board). The proportion of the wood binder not considered dry solids is water or other volatile solvents.

The wood binders described herein can have low viscosity. When the monosaccharide, the branched (poly)amine, and the fibrous material are mixed to form the binder composition, the initial viscosity can be, for example, about 5 cPs to about 500 cPs on a Brookfield viscosity instrument, preferably about 5 cPs to about 300 cPs, or more preferably about 10 cPs to about 100 cPs at a temperature of 25° C. The viscosity measurements are measured with a DV-II Brookfield Viscometer (AMTEK Brookfield, Middleboro, Mass.) using a speed of 10 rpm with a #4 spindle at 25° C.

The wood product can be produced by molding the wood product binder containing the monosaccharide, branched (poly)amine cross-linker, and fibrous material. The wood binder composition can be pressed to form the wood product. The press times to produce the final engineered wood product typically can range from only a few seconds to fifteen minutes depending on the press temperature and thickness of the panel being pressed. In general, the press temperatures typically can range from room temperature to about 250° C. The press pressures typically can range from about 25 psi to about 200 psi, more preferably from about 50 psi to about 175 psi (e.g., from about 75 psi to about 150 psi). The temperatures and press pressures used can vary based on the final pH of the wood binder composition, the protein and crosslinker utilized, the wood type utilized, the moisture content of the wood and the overall wood composite product thickness. Achieving a temperature in the middle of the product (that is typically in the form of a panel) of about 90° C. to about 105° C. for about 10 minutes is generally sufficient to cure the binder to achieve the desired panel properties.

For example, when producing a particle board, the wood binder mixture is first molded into the desired shape and thickness with conventional molds. Next, the mixture is cold pressed (typically at ambient or room temperature) at a pressure of about 5000 psi to about 5500 psi. Subsequently, the mixture is hot pressed at a temperature of about 100° C. to about 130° C. The particle board is released from the mold and cooled.

When the composite wood product comprises a particle board, the resulting wood product typically can have moisture levels from about 2 wt. % to about 15 wt. % moisture after curing. In some aspects it is preferable that the engineered wood has from 5 to 10 wt. % moisture, preferably from about 7 wt. % to 9 wt. % moisture, and more preferably from about 6 wt. % to about 9 wt. % moisture after curing.

For example, particle board produced with the wood binder described herein can, under standard wet swell testing (i.e., ASTM procedure D1037) can have less than about 40% wet swell, or preferably less than about 30% wet swell.

The cured particle board produced with the wood binders described herein can have a dry strength about 2.0 N/mm², or preferably above about 2.4 N/mm², at a density of about 0.50 g/cm³ to about 0.60 g/cm³ (e.g., about 0.51 g/cm³ to about 0.55 g/cm³).

Other composite wood products, such as particleboard (PB) or medium density fiberboard (MDF), high density fiberboard (HDF) and oriented strand board (OSB) can also be produced using the wood binder compositions using the wood binder composition described in detail above. In any of those products, the binder typically can be applied to the wood fiber or particles using any of the commercially viable binder application processes including spraying, paddle shear mixing, and blow-line, and other processes known of skill in the art to form a binder impregnated wood mat. The uncured wood can then be compressed using a cold press and then placed in a hot press similarly as described, above for the manufacture of engineered wood. A continuous press may also be used.

The binder can optionally be used to produce other products including, but not limited to, internal grade wood flooring, engineered wood flooring, HDF, MDF, or particle board as described above.

### Definitions

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% relative to the stated value or of a stated limit of a range and includes the exact stated value or range.

The term “amine” as used herein refers to primary, secondary, and tertiary amines having, e.g., the formula N(group)₃ wherein each group can independently be H or non-H, such as alkyl, aryl, and the like Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like. The term “amine” also includes ammonium ions as used herein.

The term “amino group” as used herein refers to a substituent of the form —NH₂, —NHR, —NR₂, —NR₃⁺, wherein each R is independently selected, and protonated forms of each, except for —NR₃+, which cannot be protonated. Accordingly, any compound substituted with an amino group can be viewed as an amine. An “amino group” within the meaning herein can be a primary, secondary, tertiary, or quaternary amino group. An “alkylamino” group includes a monoalkylamino, dialkylamino, and trialkylamino group.

The term “molecular weight” as used herein refers to weight-average molecular weight (M_{w}), which is equal to ΣMᵢ²nᵢ/ΣMᵢnᵢ, where nᵢ is the number of molecules of molecular weight Mᵢ. In various examples, the weight-average molecular weight can be determined using SEC (size exclusion chromatography) and MALDI-TOF (Matrix-assisted laser desorption/ionization-time of flight mass spectrometer).

The term “cure” as used herein refers to exposing to radiation in any form, heating, or allowing to undergo a physical or chemical reaction that results in hardening or an increase in viscosity.

The term “solvent” as used herein refers to a liquid that can dissolve a solid, liquid, or gas. Non-limiting examples of solvents are silicones, organic compounds, water, alcohols, ionic liquids, and supercritical fluids.

The term “independently selected from” as used herein refers to referenced groups being the same, different, or a mixture thereof, unless the context clearly indicates otherwise. Thus, under this definition, the phrase “X¹, X², and X³ are independently selected from noble gases” would include the scenario where, for example, X¹, X², and X³ are all the same, where X¹, X², and X³ are all different, where X¹ and X² are the same but X³ is different, and other analogous permutations.

The term “room temperature” as used herein refers to a temperature of about 15° C. to 28° C.

The term “standard temperature and pressure” as used herein refers to 20° C. and 101 kPa.

### EXAMPLES

Aspects of the present disclosure can be better understood by reference to the following Examples which are offered by way of illustration. The present disclosure is not limited to the Examples given herein. For Examples 1-5 and the associated Tables, unless indicated to the contrary, Parts Binder/100 part dry weight wood refers to the parts dry binder based on 100 parts dry wood fiber; the wood used in the examples had a moisture content of from about six percent by weight (6 wt %) to about nine weight percent (9 wt %); and % Fructose, % NaOH, and % Cross-linker refer to dry weight percent of the indicated component based on the total dry weight of the binder composition.

### Example 1—Fructose Binder with Polyamine Crosslinkers

In Example 1, binders were made with branched (poly)amine crosslinkers and fructose. The samples were prepared in laboratory. The aqueous fructose binders were prepared with aqueous solutions containing 75 wt % fructose (fructose dry powder, NOW Foods, Bloomingdale, Ill. dissolved in deionized water) and the cross-linker. The cross-linker solution was mixed with deionized (DI) water and sodium hydroxide (50% solution, Thermo Fischer Sci., Waltham, Mass.). Total moisture content of the wood fiber and binder solution was about 12 wt % to about 13 wt %.

Various primary amine containing cross-linkers were used to formulate the fructose binders, summarized in Table 1 below.

TABLE 1
Polyamine Cross-linkers.

| | Cross-linker | Structure |
|---|---|---|
| PEI | polyethylenimine | 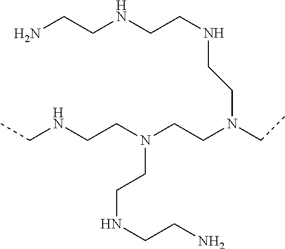 |
| TAN | 4-aminoethyl-1,8 octanediamine | 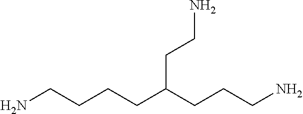 [SMILES: NCCCCC(CCN)CCCN] |
| TAEA | tris(aminoethyl)amine | 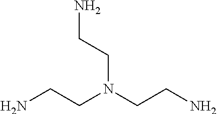 |
| PVAm | Polyvinylamine | 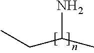 |
| DETA | Diethylenetriamine | 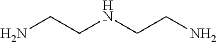 |
| TEPA | Tetraethylenepentamine | 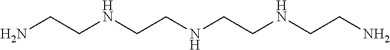 [SMILES: NCCNCCNCCNCCN] |
| PEHA | Pentaethylenehexamine | 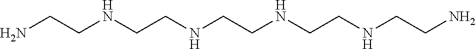 [SMILES: NCCNCCNCCNCCNCCN] |
| HMDA | Hexamethylenediamine | 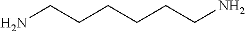 |
| EDA | Ethylenediamine | 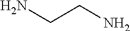 |

Sample A used a branched polyethylenimine (PEI) molecular weight (MW) 1800 (Alfa Aesar, Tweksbury, Mass.) as the cross-linking material, while Samples B and C used simple branched (poly)amines, 4-aminoethyl-1,8 octanediamine (TAN) (Ascend Petrochemical, Houston, Tex.) and tris(aminoethyl)amine (TAEA) (Sigma Aldrich, St. Louis, Mo.), respectively.

For comparison purposes, linear amines (PVAm, DETA, TEPA, PEHA, HMDA, and EDA) were also tested as crosslinker, but they did not function well.

Subsequently, the fructose solution was mixed in and shaken to prepare the binder. The produced binders had a content of about 75.5 wt % fructose, 16.0 wt % cross-linker, and 8.5 wt % sodium hydroxide of the dry solids of the binder composition. The samples made are summarized in Table 2 below.

TABLE 2
Binder compositions.

| | Sample A | Sample B | Sample C |
|---|---|---|---|
| Cross-linker | PEI | TAN | TAEA |
| Parts Binder/100 part | 12.3 | 12.1 | 12.3 |
| dry wood | | | |
| % Fructose | 75.5 | 75.5 | 75.5 |
| % NaOH | 8.5 | 8.5 | 8.5 |
| % Cross-linker | 16.0 | 16.0 | 16.0 |

Particle board binders should be fast curing and water tolerant of the resulting thermoset network. The best performing polyamine cross-linkers bear branched primary amine groups, and primary amine groups that are not hindered by adjacent groups. Branched primary amine groups are particularly good cross-linkers where they are linked to methylene groups.

PEI is a branched (poly)amine with a molecular weight of 1800 Da, where the primary amine groups are linked to methylene groups. Additionally, the viscosity of PEI may affect its curing ability for particle board applications.

In contrast, TAN and TAEA are simple branched (poly)amines They were additionally tested as cross-linkers for fructose binders. The primary amine groups of these simple compounds were connected to methylene groups.

The Samples A-C were made into particle board samples along with a wood fiber component (America's Choice Mini-Flakes, American Wood Fibers, Inc., Schofield, Wis.). To prepare the wood component, a dry content of wood fiber was measured for moisture using an HR-73 Halogen moisture measuring instrument (Mettler Toledo, Columbus, Ohio) at about 130° C. In ambient conditions, water content in the wood fibers can vary between 6 wt % and 9 wt %.

The binder (Samples A-C) was pipetted to the wood fiber and mixed using a KitchenAid® Professional 6000 mixer (Whirlpool Corporation, Benton Harbor, Mich.). Generally, the binder content was about 9 wt. % to about 12 wt. % of dry wood fiber. The wood fiber-binder mixture was transferred into an aluminum mold and sealed. The wood fiber-binder mixture was cold pressed with a Hydraulic Lab Press (Carver Inc., Wabash, Ind.) cold section at a pressure of about 5,000 to about 6,000 psi for about five to ten seconds.

The mold was then transferred to the heated lab press, which measured about 15 cm×10 cm×5 cm for particle board formation. The wood fiber-binder mixture was hot pressed at about 100 to about 130° C. for ten minutes at about 100 psi to produce particle board samples. The formed particle board was then removed from the press and the mold.

Particle boards made with the binders A-C were tested for wet swell and compared to a conventional particle board using a urea-formaldehyde (UF) cross-linker (DAP® Weldwood® Plastic Urea Formaldehyde Resin Glue, Baltimore, Md.). The UF control particle board (PB) was cured under the same conditions. The wet swell of the particle board was measured by soaking the particle board in beakers filled with tap water for 2 hours based on ASTM procedure D1037.

First, the samples of particle board were measured with calipers to obtain initial thickness values. They were measured in three areas to get an average thickness. Then, the sample particle boards were placed in 4 L glass beakers. About 2.1 to 2.2 L of cold tap water were added to each of the beakers. The sample particle boards were completely submerged for about 120 minutes. The samples were then removed and measured with the calipers for thickness. The percent wet swell was calculated based on the initial and final thicknesses. The results are shown in Table 3 below.

TABLE 3
Wet Swell Test Results.

| | Control | Sample A | Sample B | Sample C |
|---|---|---|---|---|
| Cross-linker | UF | PEI | TAN | TAEA |
| % Wet Swell | 19 | 31 | 26 | 30 |

The total water content of the combined wood fiber and binder before curing was about 12.5% by weight and about 10.7 wt % to 11.1 wt % binder to dry wood fiber. The fructose binder formulated with PEI had a strong water resistance (31% wet swell), indicating that a branched (poly)amine structure is favorable in cross-linking fructose. The samples made with TAN and TAEA also performed well.

Particle boards made with the binder samples A-C were also tested for mechanical properties. The modulus of rupture (MOR) was measured on a Model 5943 Instron® instrument using Blue Hills Software version 3.15.1343 with a 1 kN load cell (Instron®, Norwood, Mass.). An anvil of 50 mm×100 mm was used to evenly apply pressure to the samples.

The anvil was secured in the upper jaw of the Instron. The fixture holding the test piece was installed on the main horizontal platform of the machine. The particle board samples made with binder samples A, B, C, and a UF control, were each loaded onto the fixture, the board sample centered length-wise between two end rods of the fixture. The anvil was aligned with the center of the sample with 2-3 mm clearance above the sample particle board.

After pressing start, the anvil slowly descended at 25 mm per minute, pushing down at the center of the sample particle board. When the sample particle board reached the point where it could no longer take pressure, the sample board would rupture. The force exerted by the anvil was recorded in kgF and MOR was expressed as N/mm². The results of the MOR testing are summarized in Table 4 below.

TABLE 4
MOR Test Results.

| | Control | Sample A | Sample B | Sample C |
|---|---|---|---|---|
| Cross-linker | UF | PEI | TAN | TAEA |
| MOR (N/mm²) | 2.54 | 2.84 | 2.86 | 2.53 |

Similarly, samples were made with the linear amines PVAm, DETA, TEPA, PEHA, HMDA, and EDA. The samples made with linear amines had about 9 wt % binder by dry weight of binder and particle board, about 75.5 wt % fructose in the binder, about 8.5 wt % sodium hydroxide, and about 16 wt % cross-linker. The samples made with linear amines had dry strengths ranging from about 0.14 to about 1.3 N/mm², and wet swell of about 33% to about 106%. Some of the samples made with linear amines broke during wet swell testing.

By comparison, the samples made with branched (poly)amines (PEI, TAN) had a about 9 wt % binder in the particle board, about 75.5 wt % fructose in the binder, about 8.5 wt % sodium hydroxide, and about 16 wt % cross-linker. The samples made with the branched (poly)amines performed well, having MOR measurements of greater than about 2.18 N/mm² and wet swell measurements of less than about 40%. Overall, the PEI and TAN cross-linkers exhibited the highest dry strength and water resistance, but the samples performed comparably to the control using a UF cross-linker.

### Example 2—Binder with Reaction Product Cross-Linkers

In Example 2, binders were made with polyamine crosslinkers derived from reaction products of trimethylolpropane triglycidyl ether (TMPTGE) (Cargill®, Minnetonka, Minn.) with ethylenediamine (EDA) (Acros Organics, Geel, Belgium). The resulting cross-linker compound can be seen below:

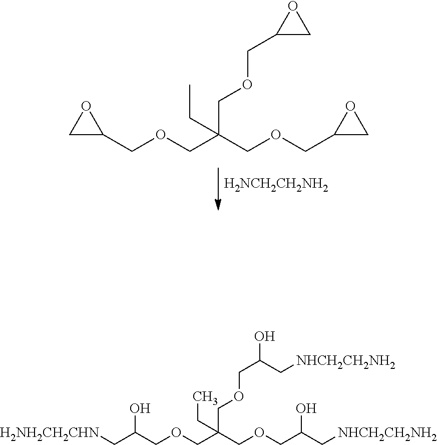

The reaction of TMPTGE with EDA produced active branched (poly)amines by introducing amine groups to a trifunctional compound. The resulting product was a highly branched polymer or oligomer with primary amines connected to secondary carbons (or methylene groups). The monomer ratio of EDA to TMPTG was larger than 3. The reaction produced polymers and oligomers with the weight average molecular weight ranging from about 482 to about 65,000. The average molecular weight was determined by SEC/RID, using TSKgel G2000PWxl-CP and G5000PWxl-CP SEC columns and PEG/PEO as calibration standards. The testing was performed at 0.8 mL/min flow rate with 0.2M NaNO₃ as mobile phase. The column temperature was controlled at 30° C.

Specifically, the reaction product cross-linker was begun by adding about 28.0 g EDA to a round bottom flask. The molar ratio of EDA to TMPTGE in this reaction was 5:1. Under nitrogen protection and mechanical agitation, the addition of an initial portion 20 wt % of TMPTGE was added into the reaction flask at 35° C. within 15 minutes. Then, the reaction temperature was raised to about 45° C. The remaining TMPTGE was added dropwise to the reaction mixture over 2.5 hours. After the reaction proceeded for about 14 hours, the temperature was increased to about 55° C. for 2 hours. The reaction was stopped and cooled to room temperature. The resulting product was transferred to a round bottom flask. The flask was then placed on a rotavapor to remove excess EDA at a 20-25 torr vacuum at about 125° C. to about 130° C.

Binders using the cross-linker compound, fructose, and sodium hydroxide were produced as shown below in Table 5. The samples were produced with about 20 wt %, 18 wt % and 16 wt % of the cross-linker.

TABLE 5
Binders using the TMPTGE and EDA reaction product cross-linker.

| | Sample D | Sample E | Sample F |
|---|---|---|---|
| Composition | TMPTGE × EDA produced cross-linker | | |
| Parts Binder/100 part | 10.1 | 10.0 | 10.1 |
| dry wood | | | |
| % Cross-linker | 19.9 | 17.9 | 16.0 |
| % Fructose | 72.1 | 73.8 | 75.6 |
| % NaOH | 7.9 | 8.2 | 8.4 |

The Samples D, E, and F were combined with wood fiber and pressed into particle boards as described in reference to Example 1. The sample particle boards were tested for wet swell and modulus of rupture (MOR) with the procedures described in reference to Example 1. The results of those tests are summarized in Table 6 below, in comparison to a UF particle board as a control. The UF binder content is around 10 part per 100 parts dry wood fiber.

TABLE 6
Testing of particle board made with the reaction product cross-linker.

| | Control | Sample D | Sample E | Sample F |
|---|---|---|---|---|
| % Cross-linker | — | 19.9 | 17.9 | 16.0 |
| MOR (N/mm²) | 2.38 | 2.60 | 2.50 | 2.22 |
| % Wet Swell | 27 | 27 | 31 | 31 |

Overall, the samples made with the reaction product cross-linker had a dry strength in the range of about 2.2 N/mm² to about 2.60 N/mm² at a density of about 0.50 g/cm³ to about 0.60 g/cm³ (e.g., about 0.51 g/cm³ to about 0.55 g/cm³), which is comparable to the control particle board made with a conventional UF cross-linker. The wet swell of the samples D-F was also comparable to conventional particle board binder.

For comparison, other highly branched (poly)amines were tested, including Jeffamine® T403 polyoxypropylenetriamine from Huntsman (UL, Northbrook, Ill.) (“Jeffamine”):

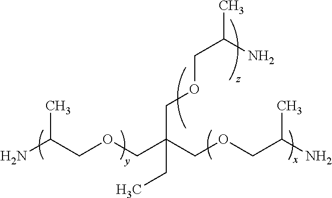

However, Jeffamine® T403 is sterically hindered, and did not perform as well as the reaction product cross-linker. The samples also performed poorly with MOR testing, either breaking before a dry strength could be recorded, or resulting in a dry strength of about 0.45 N/mm² at a density of about 0.51 g/cm³ to about 0.55 g/cm³. Jeffamine® T403 samples also produced a wet swell of over 84%.

Jeffamine® T403 had a low reactivity, likely due to the steric effect of the methyl groups adjacent the amine groups, which block the amine groups to prevent the reaction between the amines and fructose. For this reason, primary amine groups attached to tertiary carbons can be less effective than other cross-linkers.

### Example 3—Binder with Sodium Hydroxide

In Example 3, PEI/fructose binders were made with varying amounts of an alkalizer, sodium hydroxide. The compositions are summarized below in Table 7.

TABLE 7
Binders with Varying Sodium Hydroxide.

| | Sample G | Sample H | Sample I | Sample J | Sample K |
|---|---|---|---|---|---|
| Cross- | PEI | PEI | PEI | PEI | PEI |
| Linker | | | | | |
| Parts | 12.3 | 12.2 | 12.2 | 12.2 | 12.3 |
| Binder/100 | | | | | |
| part dry | | | | | |
| wood | | | | | |
| % Cross- | 15.8 | 15.9 | 16.0 | 16.0 | 16.1 |
| Linker | | | | | |
| % Fructose | 71.8 | 75.6 | 79.1 | 81.5 | 83.9 |
| % NaOH | 12.4 | 8.5 | 5.0 | 2.5 | 0.0 |

The sample with varying levels of sodium hydroxide were mixed with wood fiber and pressed to create sample particle boards as described in reference to Example 1. The sample particle boards were then tested for wet swell and MOR with the procedures described in reference to Example 1. The results are summarized in Table 8 below.

TABLE 8
Sample wet swell and dry strength.

| | Sample G | Sample H | Sample I | Sample J | Sample K |
|---|---|---|---|---|---|
| MOR, | 2.87 | 3.06 | 2.63 | 2.73 | 2.43 |
| (N/mm²) | | | | | |
| % Wet Swell | 28% | 29% | 29% | 30% | 30% |

Sodium hydroxide can neutralize sugar acids generated in the curing process. This can prevent amines from being protonated. Sodium hydroxide may also interact with wood fiber, facilitating dispersion of wood binder throughout the particle board. The particle board samples made with PEI in the presence of sodium hydroxide allowed stronger particle boards compared to samples with little or no alkalizer.

Additionally, binder samples were prepared with TAN as the cross-linker and varying amounts of sodium hydroxide. The TAN binders, and their measured properties, are summarized in Tables 9-10 below.

TABLE 9
Samples Using Varying Amounts of NaOH.

| | Sample L | Sample M | Sample N | Sample O | Sample P | Sample Q |
|---|---|---|---|---|---|---|
| Cross- | TAN | TAN | TAN | TAN | TAN | TAN |
| Linker | | | | | | |
| Parts | 10.0 | 9.9 | 9.9 | 10.0 | 9.9 | 9.9 |
| Binder/100 | | | | | | |
| part dry | | | | | | |
| wood | | | | | | |
| % Cross- | 17.9 | 17.9 | 18.0 | 17.8 | 17.9 | 18.1 |
| Linker | | | | | | |
| % Fructose | 82.1 | 78.7 | 75.4 | 74.0 | 72.3 | 70.4 |
| % NaOH | 0 | 3.3 | 6.6 | 8.2 | 9.8 | 11.5 |
| MOR | 2.59 | 2.73 | 2.55 | 2.83 | 2.92 | 2.71 |
| (N/mm²) | | | | | | |
| Wet Swell | 27.2 | 26.1 | 26 | 27 | 26 | 26 |
| % | | | | | | |

TABLE 10
Samples Using Varying Amounts of NaOH.

| | Sample R | Sample S | Sample T | Sample U | Control |
|---|---|---|---|---|---|
| Cross-Linker | TAN | TAN | TAN | TAN | UF |
| Parts | 10.0 | 10.0 | 9.9 | 10.0 | 10.0 |
| Binder/100 | | | | | |
| part dry | | | | | |
| wood | | | | | |
| % Cross- | 17.9 | 17.9 | 18.0 | 17.8 | — |
| Linker | | | | | |
| % Fructose | 82.1 | 78.7 | 75.4 | 74.0 | — |
| % NaOH | 8.2 | 16.5 | 24.6 | 33.0 | — |
| MOR | 2.42 | 2.57 | 2.14 | 1.37 | 2.46 |
| (N/mm²) | | | | | |
| Wet Swell % | 25 | 24 | 25 | 50 | 24 |

Dry strength increased with the addition of sodium hydroxide for many samples. However, the samples using more than 25 wt % sodium hydroxide (based on the dry weight of the binder composition) showed a significant drop in dry strength of the particle board samples.

The reaction product of TMPTGE and EDA was also used as a cross-linker in binder samples testing varying amounts of sodium hydroxide. These samples, and the properties of particle boards made with these binders, are summarized in Table 11.

TABLE 11
Reaction Product Binder Compositions.

| | Sample V | Sample W | Sample X | Sample Y | Sample Z | Control |
|---|---|---|---|---|---|---|
| Cross- | Reaction | Reaction | Reaction | Reaction | Reaction | UF |
| Linker | Product | Product | Product | Product | Product | |
| Parts | 10.1 | 10.1 | 10.1 | 10.1 | 10.0 | 10.0 |
| Binder/100 | | | | | | |
| part dry | | | | | | |
| wood | | | | | | |
| % Cross- | 20.0 | 20.0 | 20.0 | 20.0 | 20.0 | — |
| Linker | | | | | | |
| % Fructose | 68.8 | 70.2 | 71.9 | 73.5 | 80.0 | — |
| % NaOH | 11.2 | 9.8 | 8.1 | 6.4 | 0 | — |
| MOR | 2.46 | 2.39 | 2.44 | 2.31 | 2.29 | 2.26 |
| (N/mm²) | | | | | | |
| Wet Swell | 25 | 28 | 27 | 28 | 27 | 27 |
| % | | | | | | |

The surface of hot particle board samples made with the binder containing the reaction product cross-linker were sticky in the absence of sodium hydroxide, which caused mold release issues. The dry strength of the particle board samples improved with the addition of sodium hydroxide, indicating that sodium hydroxide played a positive role in the reactions of fructose and branched (poly)amines.

### Example 4—Binder with Alternative Carbohydrates

In Example 4, binders were made with polyamine crosslinkers and various carbohydrates. High fructose syrups, dextrose, and HMF were used in addition to fructose. The binder formulated with PEI and varying carbohydrates are summarized in Table 12. The binders were made into particle boards and tested as described in reference to Example 1.

TABLE 12
Binders formulated with varying carbohydrates and PEI.

| | Sample | Sample | Sample | Sample | Sample |
|---|---|---|---|---|---|
| | AA | BB | CC | DD | EE |
| Carbo- | Fructose | Syrup #1 | Syrup #2 | Dextrose | HMF |
| hydrate | | | | | |
| Parts | 12.4 | 12.3 | 12.3 | 12.2 | 12.8 |
| Binder/100 | | | | | |
| part dry | | | | | |
| wood | | | | | |
| Cross- | PEI | PEI | PEI | PEI | PEI |
| Linker | | | | | |
| % Cross- | 16.1 | 15.9 | 16.0 | 16.0 | 16.0 |
| Linker | | | | | |
| % | 75.5 | 75.6 | 75.7 | 75.6 | 75.6 |
| Carbo- | | | | | |
| hydrate | | | | | |
| % NaOH | 8.5 | 8.4 | 8.3 | 8.4 | 8.4 |
| MOR | 2.78 | 2.97 | 2.97 | 2.93 | 3.22 |
| (N/mm²) | | | | | |
| % Wet | 28 | 27 | 27 | 28 | 31 |
| Swell | | | | | |

Additionally, samples with varying carbohydrates were formulated with TAN, as summarized in Table 13.

TABLE 13
Binders formulated with varying carbohydrates and TAN.

| | Control | Sample FF | Sample GG | Sample HH |
|---|---|---|---|---|
| Carbohydrate | — | Fructose | Syrup #1 | Syrup #2 |
| Cross-Linker | UF | TAN | TAN | TAN |
| Parts Binder/100 | 10.0 | 9.9 | 9.9 | 9.8 |
| part dry wood | | | | |
| % Cross-Linker | — | 18.0 | 18.0 | 18.0 |
| % Carbohydrate | — | 73.8 | 73.8 | 73.8 |
| % NaOH | — | 8.2 | 8.2 | 8.2 |
| MOR (N/mm²) | 2.04 | 2.12 | 2.01 | 2.04 |
| % Wet Swell | 27 | 25 | 26 | 27 |

The samples in Tables 12 and 13 were made and tested by the methods described above in reference to Examples 1-3.

High fructose syrups #1 and #2 were Isoclear® 42 HFCS containing about 43 wt % fructose and about 52 wt % dextrose and Isoclear® 55 HFCS containing about 56 wt % fructose and about 40 wt % dextrose, respectively, available from Cargill® (Minnetonka, Minn., US). Particle board samples made with both high fructose syrups exhibited comparable dry strength and water resistance to the fructose-only samples. Thus, high fructose corn syrup is potentially useable as the carbohydrate in these binders.

### Example 5. Viscosity of Binder Compositions

Several binder compositions samples were tested for initial viscosity. The samples tested were prepared as described above with reference to Examples 1-4. The samples tested for viscosity are summarized in Table 14 below:

TABLE 14
Viscosity Measurements.

| | Carbo- | Cross- | | | Centi- |
|---|---|---|---|---|---|
| | hydrate | linker | Alkaline | DS | poise(cP) |
| Sample II | Fructose | TAN | NaOH | 63wt % | 40 |
| Sample JJ | Fructose | PEI | NaOH | 55wt % | 25 |
| | | MW | | | |
| | | 2,000 | | | |
| Sample LL | Fructose | PEI | NaOH | 55wt % | 100 |
| | | MW | | | |
| | | 750,000 | | | |
| Sample | Corn Syrup | PEI | NaOH | 59wt % | 155 |
| MM | 63DE | MW | | | |
| | | 2,000 | | | |
| Sample | Corn Syrup | PEI | NaOH | 59wt % | 245 |
| NN | 43DE | MW | | | |
| | | 2,000 | | | |

The initial viscosity was recorded within about 20 minutes of the binder composition being mixed together. Prior to viscosity measurements, the samples were cooled to 25° C. to counteract the exothermic nature of the mixing process. The viscosity measurements in Table 14 were taken with a DV-II Brookfield Viscometer (AMTEK Brookfield, Middleboro, Mass.). The samples were tested at a speed of 10 rpm with a #4 spindle at 25° C.

Two corn syrups, with dextrose equivalents (DE) of approximately 63 and approximately 43 were tested. Samples using PEI at molecular weights (MW) of 2,000 and 750,000 were tested, in addition to a sample using TAN as the cross-linker. Overall, the fructose/TAN sample had the lowest viscosity.

The terms and expressions that have been employed are used as terms of description and not of limitation, and there is no intention in the use of such terms and expressions of excluding any equivalents of the features shown and described or portions thereof, but it is recognized that various modifications are possible within the scope of aspects of the present disclosure. Thus, it should be understood that although the present disclosure has been specifically disclosed as aspects and optional features, modification and variation of the concepts herein disclosed may be resorted to by those of ordinary skill in the art, and that such modifications and variations are considered to be within the scope of the present disclosure.

### Additional Aspects.

The following aspects are provided, the numbering of which is not to be construed as designating levels of importance:

Aspect 1 includes a composition including a fibrous material; and a binder composition including at least one carbohydrate; at least one branched (poly)amine comprising a plurality of primary amines, wherein the majority of the plurality of primary amines are adjacent to a methylene group; and an alkalizing agent comprising sodium hydroxide, potassium hydroxide, magnesium hydroxide, calcium hydroxide, or mixtures thereof.

Aspect 2 includes Example 1, wherein the fibrous material comprises a plurality of wood fibers, cellulosic fibers, or combinations thereof.

Aspect 3 includes any of Aspects 1-2, wherein the at least one carbohydrate and the at least one branched (poly)amine are mixed prior to being subjected to reaction conditions.

Aspect 4 includes any of Aspects 1-3, wherein the branched (poly)amine comprises at least three (primary) amines.

Aspect 5 includes any of Aspects 1-4, wherein the composition has a pH of at least 9.0.

Aspect 6 includes any of Aspects 1-5, further comprising an alkalizing agent comprising sodium hydroxide, potassium hydroxide, magnesium hydroxide, or calcium hydroxide.

Aspect 7 includes any of Aspects 1-6, wherein the alkalizing agent is about 0.1 wt. % to about 25.0 wt. % of the composition.

Aspect 8 includes any of Aspects 1-7, wherein at least one carbohydrate is a monosaccharide.

Aspect 9 includes any of Aspects 1-8, wherein the monosaccharide is fructose, glucose, galactose, mannose, or combinations thereof.

Aspect 10 includes any of Aspects 1-9, wherein the at least one carbohydrate comprises a high fructose syrup.

Aspect 11 includes any of Aspects 1-10, wherein the at least one branched (poly)amine has one of the following structures:

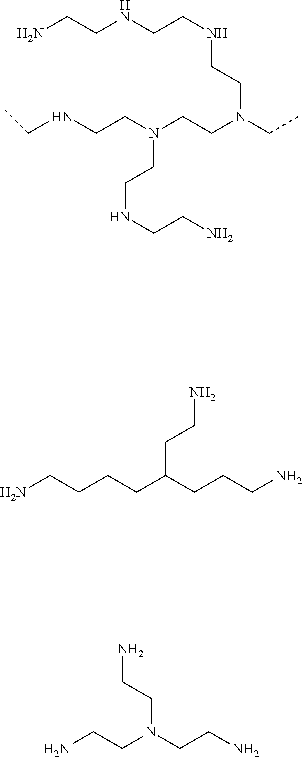

Aspect 12 includes any of Aspects 1-11, wherein the at least one branched (poly)amine is polyethylenimine, 4-aminomethyl-1,8 octanediamine, tris(aminoethyl)amine, or combinations thereof.

Aspect 13 includes any of Aspects 1-12, wherein the at least one branched (poly)amine is the reaction product of trimethylolpropane triglycidyl ether and ethylenediamine, diethylenetriamine, triethylenetetramine, tetraethylenepentamine, pentaethylenehexamine, ammonia, or combinations thereof.

Aspect 14 includes any of Aspects 1-13, wherein the reaction product comprises:

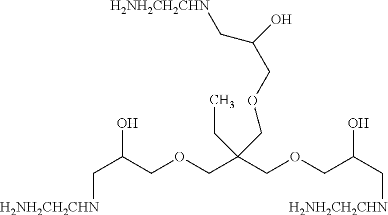

Aspect 15 includes any of Aspects 1-14, wherein the reaction product comprises:

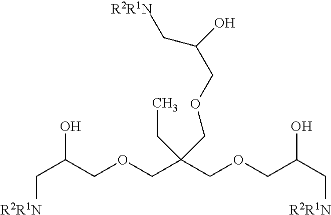

wherein R¹ is hydrogen or R³, and wherein R³ comprises:

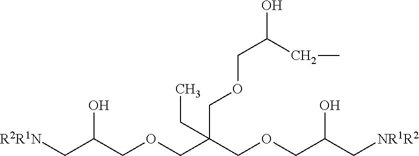

wherein R² is hydrogen, —(CH₂)ₙNR⁴R⁵ or —(CH₂CH₂N R₄R₅)ₘ CH₂CH₂NR⁴R⁵; wherein n is an integer from 2 to 9, and m is an integer from 1 to 4; and wherein R⁴ and R⁵ are hydrogen or R³.

Aspect 16 includes any of Aspects 1-15, wherein the molecular weight of the at least one branched (poly)amine is about 140 g/mol to about 750,000 g/mol.

Aspect 17 includes any of Aspects 1-16, wherein the molecular weight of the at least one branched (poly)amine is about 140 g/mol to about 65,000 g/mol.

Aspect 18 includes any of Aspects 1-17, wherein the binder composition comprises about 20.0 wt. % to about 95.0 wt. % of the at least one carbohydrate.

Aspect 19 includes any of Aspects 1-18, wherein the binder composition comprises about 50.0 wt. % to about 80.0 wt. % of the at least one carbohydrate.

Aspect 20 includes any of Aspects 1-19, wherein the binder composition comprises about 10.0 wt. % to about 80.0% of the at least one branched (poly)amine.

Aspect 21 includes any of Aspects 1-20, wherein the binder composition comprises about 12.0 wt. % to about 30.0 wt. % of the at least one branched (poly)amine.

Aspect 22 includes any of Aspects 1-21, wherein the binder composition has an initial viscosity of about 5 cPs to about 1,000 cPs.

Aspect 23 includes any of Aspects 1-22, wherein the binder composition has an initial viscosity of about 10 cPs to about 300 cPs.

Aspect 24 includes any of Aspects 1-23, wherein the binder composition has an initial viscosity of about 10 cPs to about 100 cPs.

Aspect 25 includes a composition including the reaction product of: at least one monosaccharide; and at least one branched (poly)amine comprising a plurality of primary amines, wherein each of the plurality of primary amines is attached to a methylene group; and the composition further comprises a fibrous material mixed with the reaction product.

Aspect 26 includes Aspect 25, wherein the reaction product further includes an alkalizing agent.

Aspect 27 includes any of Aspects 25-26, wherein the fibrous material comprises a plurality of wood fibers, cellulosic fibers, or combinations thereof.

Aspect 28 includes an engineered wood product comprising the composition of claim 27.

Aspect 29 includes any of Aspects 28-28, wherein the engineered wood product is a particle board, an oriented strand board or a fiber board.

Aspect 30 includes any of Aspects 28-29, wherein the engineered wood product comprises about 5 wt. % to about 30 wt. % of the dry weight of the reaction product and fibrous material.

Aspect 31 includes any of Aspects 28-28, wherein the engineered wood product has a dry strength of at least 2.0 N/mm² at a density of about 0.50 g/cm³ to about 0.60 g/cm³.

Aspect 32 includes any of Aspects 28-31, wherein the engineered wood product has a dry strength of at least 3.8 N/mm².

Aspect 33 includes any of Aspects 28-28, wherein the engineered wood product has a wet swell percent of 40% or less under standard wet swell testing procedure.

Aspect 34 includes any of Aspects 28-33, wherein the engineered wood product has a wet swell percent of 30% or less under standard wet swell testing procedure.

Aspect 35 includes a method of making an engineered wood product including combining at least one monosaccharide with at least one branched (poly)amine comprising a plurality of primary amines, wherein each of the plurality of primary amines is attached to a methylene group to form a binder composition; combining the binder composition with a fibrous material to form a mixture of the fibrous material and the binder composition; and curing the mixture.

Aspect 36 includes the method of Example 35, further comprising combining an alkalizing agent with the at least one monosaccharide and the at least one branched (poly)amine prior to curing the mixture.

Aspect 37 includes any of Aspects 35-35, further comprising molding the mixture.

Aspect 38 includes any of Aspects 35-35, wherein forming the PB comprises cold pressing the mixture.

Aspect 39 includes any of Aspects 35-38, wherein cold pressing is performed at a pressure of about 5000 psi to about 5500 psi.

Aspect 40 includes any of Aspects 35-35, wherein forming the PB comprises hot pressing the mixture.

Aspect 41 includes any of Aspects 35-40, wherein hot pressing the PB comprises pressing the mixture at a temperature of about 100° C. to about 130° C.

1. A composition comprising:
a fibrous material comprising a plurality of wood fibers, cellulosic fibers or a combination thereof; and
a binder composition comprising:
at least one carbohydrate;
at least one branched (poly)amine comprising a plurality of primary amines, wherein the majority of the plurality of primary amines are adjacent to a methylene group; and
an alkalizing agent comprising sodium hydroxide, potassium hydroxide, magnesium hydroxide, calcium hydroxide, or mixtures thereof.

2. (canceled)

3. (canceled)

4. The composition of claim 2, wherein the branched (poly)amine comprises at least three primary amines.

5. The composition of claim 1, wherein the composition has a pH of at least 9.0.

6. The composition of claim 1, wherein the alkalizing agent comprises sodium hydroxide.

7. The composition of claim 6, wherein the alkalizing agent is about 0.1 wt. % to about 25.0 wt. % based on dry weight of the binder composition.

8. (canceled)

9. (canceled)

10. The composition of claim 8, wherein the at least one carbohydrate comprises comprises fructose, glucose or mixtures thereof.

11. (canceled)

12. The composition of claim 1, wherein the at least one carbohydrate comprises a high fructose syrup.

13. (canceled)

14. The composition of claim 1, wherein the at least one carbohydrate comprises a corn syrup having a dextrose equivalent of 80 to 95.

15. The composition of claim 1, wherein the at least one branched (poly)amine has one of the following structures:

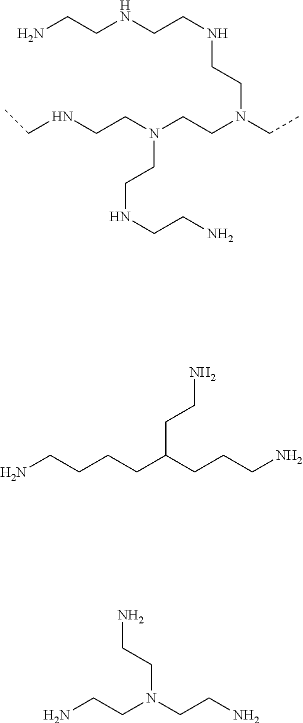

16. (canceled)

17. The composition of claim 1, wherein the at least one branched (poly)amine comprises the reaction product of trimethylolpropane triglycidyl ether and ethylenediamine, diethylenetriamine, triethylenetetramine, tetraethylenepentamine, pentaethylenehexamine, ammonia, or combinations thereof.

18. The composition of claim 17, wherein the reaction product comprises:

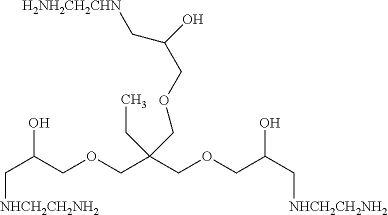

19. The composition of claim 17, wherein the reaction product comprises: 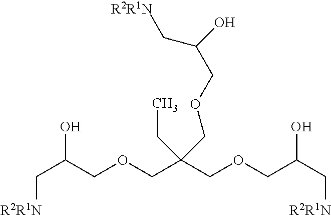
wherein R¹ is hydrogen or R³, and wherein R³ comprises: 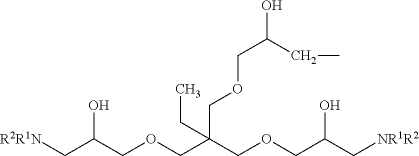
wherein R² is hydrogen, —(CH₂)ₙNR⁴R⁵ or —(CH₂ CH₂ N R⁴R⁵)ₘ CH₂ CH₂NR⁴R⁵;
wherein n is an integer from 2 to 9, and m is an integer from 1 to 4; and
wherein R⁴ and R⁵ are hydrogen or R³.

20. (canceled)

21. (canceled)

22. The composition of claim 1, wherein the binder composition based on dry weight comprises about 20.0 wt. % to about 95.0 wt. % of the at least one carbohydrate, and wherein the binder composition based on dry weight comprises about 10.0 wt % to about 80.0 wt % of the at least one branched (poly)amine.

23.-25. (canceled)

26. The composition of claim 1, wherein the binder composition has an initial viscosity of about 5 cPs to about 1,000 cPs.

27.-31. (canceled)

32. An engineered wood product comprising the reaction product of the composition of claim 1.

33. The engineered wood product of claim 32, wherein the engineered wood product is a particle board, an oriented strand board or a fiber board.

34. The composition of claim 1, wherein the binder composition comprises about 5 wt. % to about 30 wt. % of the dry weight of the fibrous material and the binder composition.

35. The engineered wood product of claim 33, wherein the engineered wood product has a dry strength of at least 2.0 N/mm² at a density of about 0.50 g/cm³ to about 0.60 g/cm³.

36. (canceled)

37. The engineered wood product of claim 35, wherein the engineered wood product has a wet swell percent of 40% or less under standard wet swell testing procedure.

38. The engineered wood product of claim 37, wherein the engineered wood product has a wet swell percent of 30% or less under standard wet swell testing procedure.

39.-47. (canceled)
